(19) United States
(12) Patent Application Publication
(10) Pub. No.: US 2013/0110780 A1
(43) Pub. Date: May 2, 2013

(54) RELAY APPARATUS AND DATA COPY METHOD

(71) Applicant: FUJITSU LIMITED, Kawasaki-shi (JP)

(72) Inventor: Takashi Miyoshi, Kawasaki (JP)

(73) Assignee: FUJITSU LIMITED, Kawasaki-shi (JP)

(21) Appl. No.: 13/628,647

(22) Filed: Sep. 27, 2012

(30) Foreign Application Priority Data
Nov. 2, 2011 (JP) 2011-240728

(51) Int. Cl. G06F 17/30

(52) U.S. Cl. 707/634; 707/E17.005

(57) ABSTRACT

A relay apparatus includes: a relay section that relays a communication between an information processing apparatus and one of a first storage apparatus and a second storage apparatus; a determination section that monitors the communication and to detect a first access to one of the first storage apparatus and the second storage apparatus from the information processing apparatus; and a copy section that copies data from the first storage apparatus to the second storage apparatus while one of the first storage apparatus and the second storage apparatus is not accessed in response to a copy command of the data from the first storage apparatus to the second storage apparatus.

### CROSS-REFERENCE TO RELATED APPLICATION(S)

This application is based upon and claims the benefit of priority of the prior Japanese Patent Application No. 2011-240728, filed on Nov. 2, 2011, the entire contents of which are incorporated herein by reference.

### FIELD

The embodiments discussed herein are related to a relay apparatus and a data copy method.

### BACKGROUND

When data in one storage apparatus is copied to another storage apparatus, copying is performed through a Local Area Network (LAN). Since the LAN has a narrow bandwidth, it takes long time to copy a large amount of data in operations such as a data backup.

Data copying between storage apparatuses is performed by using a Storage Area Network (SAN). For example, a computer system includes a SAN that forms a channel network, which enables to establish an arbitrary and mutual connection between a server and a storage by a Fibre Channel switch (FC switch). The computer system includes a terminal in which management-and-operation software is implemented for performing a backup operation of storage data.

A related technology is disclosed in Japanese Laid-open Patent Publication No. 2002-007304.

### SUMMARY

According to one aspect of the embodiments, a relay apparatus includes: a relay section that relays a communication between an information processing apparatus and one of a first storage apparatus and a second storage apparatus; a determination section that monitors the communication and to detect a first access to one of the first storage apparatus and the second storage apparatus from the information processing apparatus; and a copy section that copies data from the first storage apparatus to the second storage apparatus while one of the first storage apparatus and the second storage apparatus is not accessed in response to a copy command of the data from the first storage apparatus to the second storage apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary system;

FIG. 2 illustrates an exemplary system;

FIG. 3 illustrates an exemplary zoning;

FIG. 4 illustrates an exemplary switch;

FIG. 5 illustrates exemplary connection information;

FIG. 6 illustrates exemplary copy information;

FIG. 7 illustrates an exemplary copy control process;

FIG. 8 illustrates an exemplary copy control process; and

FIG. 9 illustrates an exemplary copy control process.

### DESCRIPTION OF EMBODIMENTS

When an information processing apparatus such as a server accesses a copy-source storage apparatus or a copy-destination storage apparatus during data copying between these storage apparatuses, an access conflict may occur at the storage apparatus.

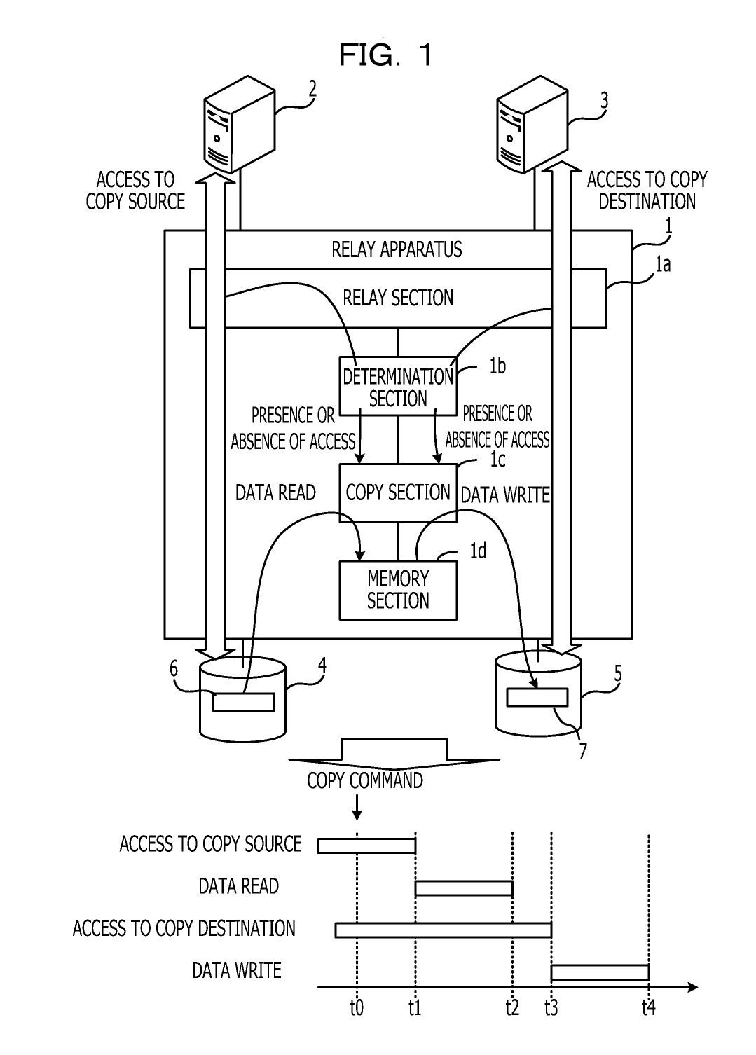

FIG. 1 illustrates an exemplary system. A relay apparatus 1 is coupled to information processing apparatuses 2 and 3 and storage apparatuses 4 and 5. In FIG. 1, for example, the information processing apparatus 2 accesses the storage apparatus 4, and the information processing apparatus 3 accesses the storage apparatus 5.

The relay apparatus 1 also relays communications between the information processing apparatuses 2 and 3 and communications between the storage apparatuses 4 and 5, and copies data between the storage apparatuses 4 and 5. The relay apparatus 1 includes a relay section 1a, a determination section 1b, a copy section 1c, and a memory section 1d.

The relay section 1a relays communications between the information processing apparatuses 2 and 3 and the first storage apparatus 4, or the information processing apparatuses 2 and 3 and the second storage apparatus 5. The determination section 1b monitors communications between the information processing apparatuses 2 and 3 and the first storage apparatus 4, or the information processing apparatuses 2 and 3 and the second storage apparatus 5. Furthermore, the determination section 1b determines whether or not there is an access from one of the information processing apparatuses 2 and 3 to the first storage apparatus 4 or the second storage apparatus 5. The determination section 1b notifies the copy section 1c of a determination result regarding presence or absence of the access.

The copy section 1c copies data 6 from the first storage apparatus 4 to the second storage apparatus 5 in response to a copy command of the data 6 from the first storage apparatus 4 to the second storage apparatus 5. The copy section 1c may copy the data 6 during a period when no access is being made to the first storage apparatus 4 or the second storage apparatus 5.

For example, the copy section 1c reads the data 6 from the first storage apparatus 4 during a period when no access is being made from the information processing apparatus 2 to the first storage apparatus 4. The copy section 1c writes copy data 7 thus read to the second storage apparatus 5 during a period when no access is being made from the information processing apparatus 3 to the second storage apparatus 5.

In the relay apparatus 1, communications between the information processing apparatuses 2 and 3 and communications between the storage apparatuses 4 and 5 are respectively relayed by the relay section 1a. These communications are monitored by the determination section 1b, and it is determined whether or not there is an access from the information processing apparatus to the first storage apparatus 4 or the second storage apparatus 5. In response to the copy command of the data 6 from the first storage apparatus 4 to the second storage apparatus 5, the copy section 1c copies the data 6 from the first storage apparatus 4 to the second storage apparatus 5. Copying the data 6 may be performed during a period when no access is being made to the first storage apparatus 4 or the second storage apparatus 5.

For example, at time t0, a copy command of the data 6 retained in the storage apparatus 4 to the storage apparatus 5 may be entered. At the time t0, the information processing apparatus 2 may be accessing the storage apparatus 4. No reading of the data 6 may be performed until the access to the storage apparatus 4 ends.

At time t1, when the access from the information processing apparatus 2 to the storage apparatus 4 ends, the data 6 is read from the storage apparatus 4. The data thus read is stored in the memory section ld of the relay apparatus 1.

At time t2, the reading of the data 6 finishes, and this data read process ends. At this moment, the information processing apparatus 3 may be accessing the storage apparatus 5 which is a copy destination. No writing of the copy data 7 may be performed until the access to the storage apparatus 5 ends.

At time t3, when the access from the information processing apparatus 3 to the storage apparatus 5 ends, the copy data 7 stored in the memory section ld is written in the storage apparatus 5. At time t4, the writing of the copy data 7 finishes, and this data copy process ends.

Conflicts of accesses to the storage apparatus 4 or 5 from the information processing apparatus 2 or 3 and accesses to the storage apparatus 4 or 5 for the data copying may be reduced. Accordingly, even during the data copying, a reduction of accessibility from the information processing apparatus 2 or 3 to the storage apparatus 4 or 5 may be reduced.

The relay section 1a, the determination section 1b, and the copy section 1c of the relay apparatus 1 may be implemented by a Central Processing Unit (CPU) or an electronic circuit included in the relay apparatus 1. The memory section id may be a Random Access Memory (RAM), a Hard Disk Drive (HDD), or the like included in the relay apparatus 1.

Lines coupling constituting elements illustrated in FIG. 1 indicate part of the communication channels, and other communication channels may also be set up in addition to the communication channels illustrated in FIG. 1. In a server system including pairs of servers and storage apparatuses, a combination of the server and the storage apparatus is modified by a disk connection network. A switch that relays communications between the servers and the storage apparatuses may be provided with a copy control mechanism. The copy control mechanism monitors communications between the servers and the storage apparatuses, and performs a copy data transfer operation during a period when no communication is taking place.

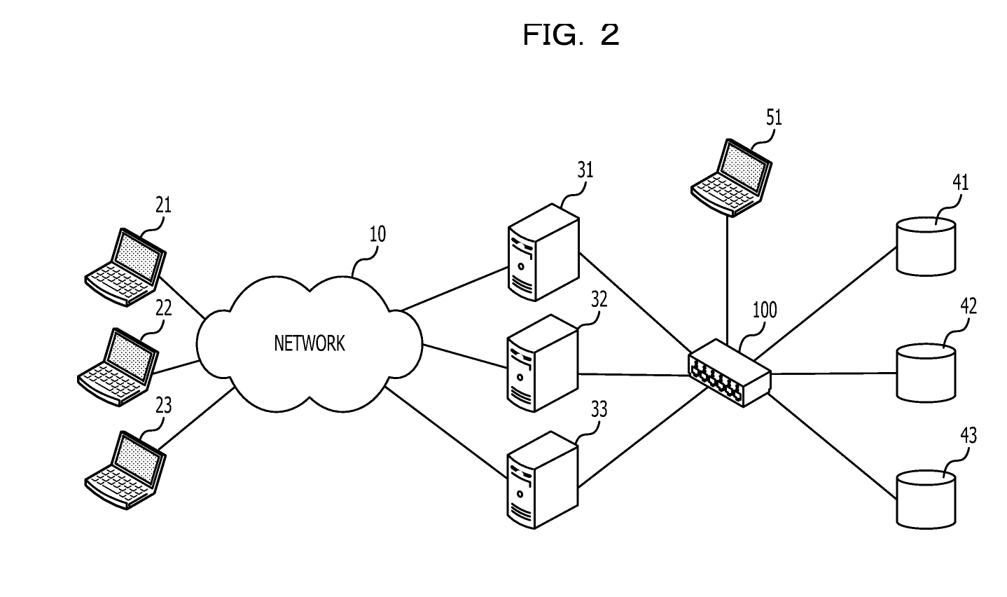

FIG. 2 illustrates an exemplary system. In the system illustrated in FIG. 2, a plurality of user terminals 21-23 are coupled to a plurality of servers 31-33 through a network 10. The network 10 may be, for example, a LAN.

The servers 31-33 are coupled to a plurality of storage apparatuses 41-43 through a switch 100. The switch 100 is further coupled to a terminal apparatus 51 for system management. A network that includes the servers 31-33, the switch 100, and the storage apparatuses 41-43 may be, for example, a Serial Attached SCSI (SAS)-2 network.

The switch 100 relays communications between the servers 31-33 and the storage apparatuses 41-43. The switch 100 may be, for example, a SAS-2 Expander. The storage apparatuses 41-43 may be SAS HDDs or Serial Advanced Technology Attachment (SATA) HDDs. The storage apparatuses 41-43 may be Solid State Drives (SSDs).

In the system, the switch 100 copies data among the storage apparatuses 41-43 in response to a command from the terminal apparatus 51. The switch 100 may perform data copying among the storage apparatuses 41-43 during a period when no access is being made to one of the storage apparatuses 41-43, which is a data read target or a data write target, from the servers 31-33. The data copying between the storage apparatuses may be performed while reducing an effect against access efficiency to the storage apparatuses 41-43 from the servers 31-33.

One of the servers is provided for one of the storage apparatuses. For example, the server and the corresponding storage apparatus form a single server system. FIG. 2 illustrates three server systems. To assign the storage apparatus to the server, one of SAS functions referred to as zoning is used. The zoning specifies allowance or rejection of each connection among the plurality of servers and the plurality of storage apparatuses, thereby limiting a range of data communications.

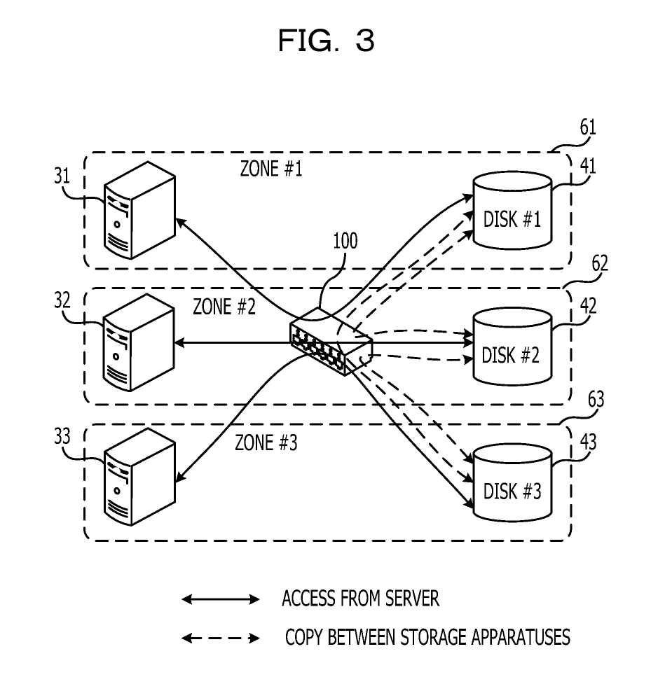

FIG. 3 illustrates an exemplary zoning. In FIG. 3, the server 31 and the storage apparatus 41 form a first zone 61. The server 32 and the storage apparatus 42 form a second zone 62. The server 33 and the storage apparatus 43 form a third zone 63. Each server accesses the storage apparatus in the same zone.

The zoning is set in the switch 100. For example, the switch 100 is set in such a way that a communication channel is established between the server and the storage apparatus, which are placed in the same zone. In the switch 100, the storage apparatuses 41-43 are identified by their identifiers. In FIG. 3, the identifier of the storage apparatus 41 may be “disk#0”, the identifier of the storage apparatus 42 may be “disk#1”, and the identifier of the storage apparatus 43 may be “disk#2”.

The switch 100 has a copy control function and performs data copying between the storage apparatuses. The data copying performed by the switch 100 may reduce loads of the servers 31-33 and allow fast data transfers since data is transferred without going through the servers 31-33.

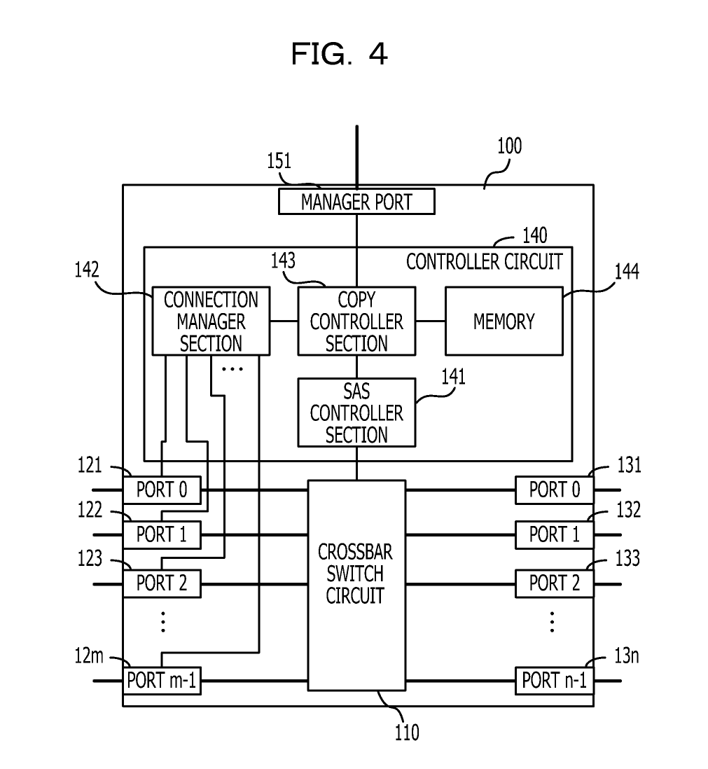

FIG. 4 illustrates an exemplary the switch 100. The switch 100 may include a crossbar switch circuit 110. The crossbar switch circuit 110 is coupled to SAS server connection ports 121, 122, 123 . . . and 12m, and SAS storage apparatus connection ports 131, 132, 133 . . . and 13n. In the crossbar switch circuit 110, switches are each provided at crosspoints of a plurality of communication channels which are parallel to each other in a longitudinal direction and a plurality of communication channels which are parallel to each other in a lateral direction. By closing or opening the switches at the crosspoints, proprietary channels are dynamically constructed among the communication channels that cross each other.

For example, in the crossbar switch circuit 110, the plurality of communication channels which are parallel to each other in the longitudinal direction are coupled to the server connection ports 121, 122, 123 . . . and 12m. In the crossbar switch circuit 110, the plurality of communication channels which are parallel to each other in the lateral direction are coupled to the storage apparatus connection ports 131, 132, 133 . . . and 13n. Thus, there is provided a proprietary communication channel coupling the server and the storage apparatus in one-to-one basis.

The switch 100 includes a controller circuit 140. The controller circuit 140 controls opening and closing of the switches of the crossbar switch circuit 110. The controller circuit 140 controls data copying between the storage apparatuses. The controller circuit 140 includes a SAS controller section 141, a connection manager section 142, a copy controller section 143, and a memory 144.

The SAS controller section 141 controls the switches in the crossbar switch circuit 110, and controls connection and disconnection of the communication channels between the server and the storage apparatus. The SAS controller section 141 includes an initiator function, and issues various commands to the storage apparatuses 41-43. For example, the SAS controller section 141 outputs a data read command to the storage apparatus based on control of the copy controller section 143. The SAS controller section 141 receives data output from the storage apparatus in response to the data read command, and transfers to the copy controller section 143. The SAS controller section 141 outputs a data write command to the storage apparatus based on control of the copy controller section 143.

The connection manager section 142 is coupled to the server connection ports 121, 122, 123 . . . and 12m, and manages connections between the servers 31-33 and the storage apparatuses 41-43. For example, the connection manager section 142 monitors commands flowing through a SAS link layer between the servers 31-33 and the storage apparatuses 41-43 through the ports 121, 122, 123 . . . and 12m. The commands to monitor may include, for example, an OPEN request (Address frame), an ACK or NACK in response to an OPEN request, a CLOSE request, etc. The connection manager section 142 manages each of connection statuses through their respective ports 121, 122, 123 . . . and 12m based on results of the command monitoring.

The connection manager section 142 notifies the copy controller section 143 of information regarding the ports 121, 122, 123 . . . and 12m. For example, the connection manager section 142 notifies the copy controller section 143 of information such as respective statuses of the ports 121, 122, 123 . . . and 12m, event contents communicated through the respective ports, numbers for the storage apparatuses to which connections are established through the respective ports, etc.

The copy controller section 143 controls data copying between the storage apparatuses. For example, the copy controller section 143 receives an input of a copy command from the terminal apparatus 51 coupled through a manager port 151. The copy controller section 143 copies data according to contents of the copy command. The copy controller section 143 may start a data copy control based on a copy schedule stored in advance.

The copy controller section 143 determines whether or not there is any access being made from the servers to the storage apparatuses that serve as a copy source and a copy destination of data based on the information obtained from the connection manager section 142 when copying data. The copy controller section 143 reads the data from the copy source storage apparatus in a period when no access is being made from the server to the copy source storage apparatus. The copy controller section 143 writes the data to the copy destination storage apparatus in a period when no access is being made from the server to the copy destination storage apparatus.

The memory 144 is coupled to the copy controller section 143 and temporarily stores the data to be copied. For example, the data read from the copy source storage apparatus by the copy controller section 143 is stored in the memory 144. As the memory 144, a RAM may be used, for example.

Various processes are performed by the foregoing hardware structure. Lines coupling elements illustrated in FIG. 4 indicate part of the communication channels, and other communication channels may also be set up in addition to the communication channels illustrated in FIG. 4.

The relay apparatus 1 may include, for example, hardware substantially the same as that of the switch 100 illustrated in FIG. 4. The crossbar switch circuit 110 illustrated in FIG. 4 may correspond to, for example, the relay section 1a illustrated in FIG. 1. The connection manager section 142 illustrated in FIG. 4 may correspond to, for example, the determination section 1b illustrated in FIG. 1. The copy controller section 143 illustrated in FIG. 4 may correspond to, for example, the copy section 1c illustrated in FIG. 1. The memory 144 illustrated in FIG. 4 may correspond to, for example, the memory section id illustrated in FIG. 1.

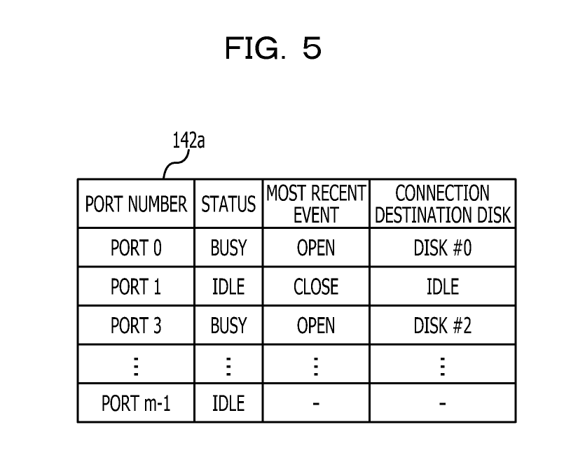

FIG. 5 illustrates exemplary connection information. Connection information 142a is provided with columns for a port number, a status, a most recent event, and a connection destination disk.

In the column of the port number, the port numbers of the server connection ports 121, 122, 123 . . . and 12m are set. In the column of the status, the status of the corresponding port is set. The status may include, for example, “busy” and “idle”. The “busy” status indicates that a connection is established and now being used for communications. The “idle” status indicates that no connection is established.

In the column of the most recent event, the most recent event input from the corresponding port is set. The event may include, for example, “OPEN” and “CLOSE”. The “OPEN” event indicates a start of establishing a connection. The “CLOSE” event indicates a disconnection of an established connection.

In the column of the connection destination disk, identification information of the storage apparatus, to which a connection is established from the server that is coupled to the corresponding port, is set. The connection manager section 142 retains the connection information 142a in an internal memory, and updates the connection information 142a in response to contents of commands communicated through each port.

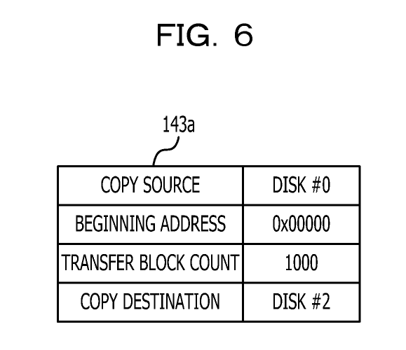

The copy command is sent to the copy controller section 143. The copy command includes copy information indicating contents of a copy process. FIG. 6 illustrates exemplary copy information. Copy information 143a includes fields for a copy source, a beginning address, a transfer block count, and a copy destination. In the field of the copy source, an identification number of the copy source storage apparatus is set. In the field of the beginning address, a beginning address of copy target data in the copy source storage apparatus is set. In the field of the transfer block count, a volume of the copy target data is set in block count. The volume of one block may be a preset value. In the field of the copy destination, an identification number of the copy destination storage apparatus is set.

When the copy command including the copy information 143a is input to the copy controller section 143, the copy controller section 143 stores the copy information 143a in a memory space such as a memory and starts a copy control according to the copy information 143a.

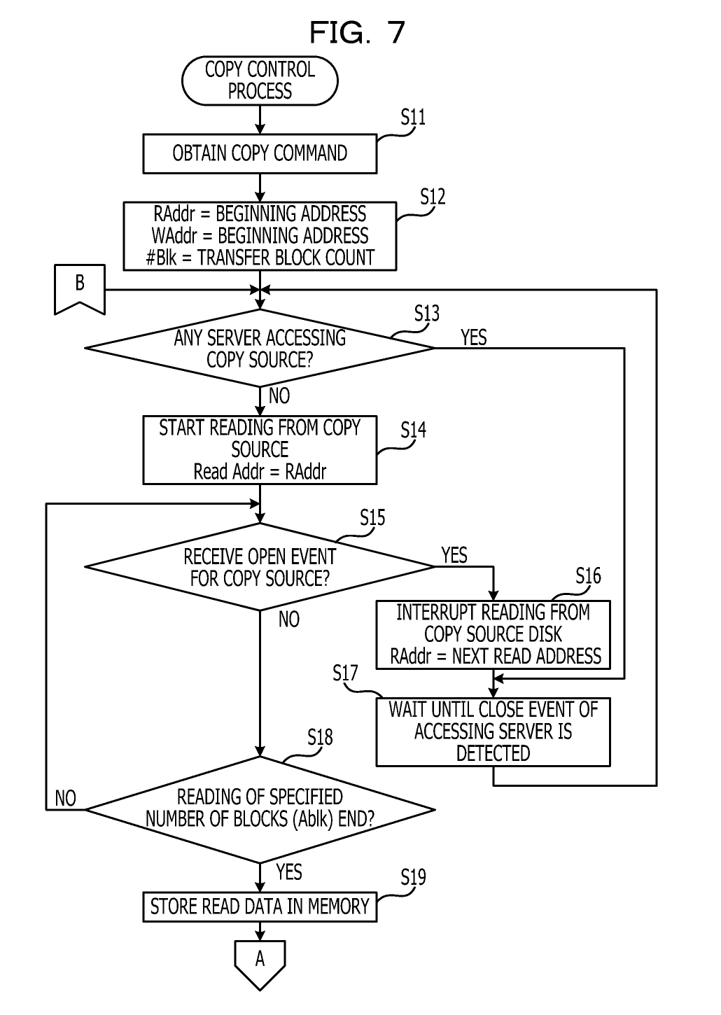

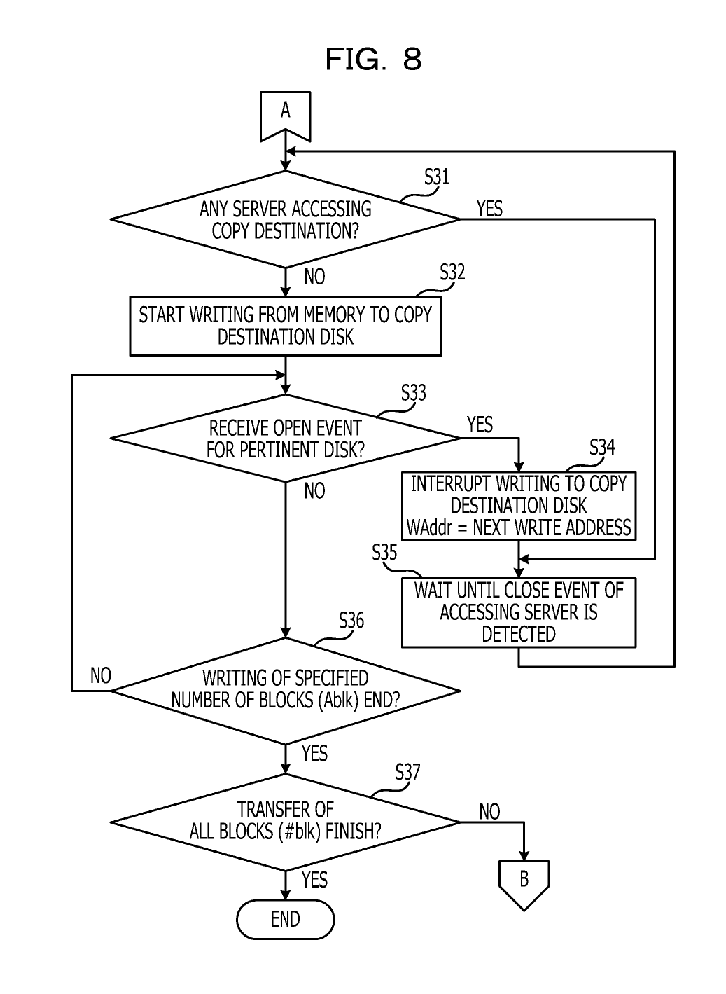

FIG. 7 and FIG. 8 illustrate an exemplary copy control process.

(Operation S11) The copy controller section 143 obtains a copy command. For example, the copy controller section 143 obtains the copy command from the terminal apparatus 51 coupled to the manager port 151. The copy controller section 143 stores the copy information 143a (see FIG. 6) indicated in the obtained copy command, for example, in an internal memory.

(Operation S12) The copy controller section 143 initializes variables. For example, the copy controller section 143 sets the beginning address indicated in the copy information 143a to a variable “RAddr” that indicates a read start address. The copy controller section 143 sets the beginning address indicated in the copy information 143a to a variable “WAddr” that indicates a write start address. The copy controller section 143 sets the transfer block count indicated in the copy information 143a to a variable “#Blk” that indicates the number of blocks of the copy target data.

(Operation S13) The copy controller section 143 determines whether or not a server accessing the copy source storage apparatus exists or not. For example, the copy controller section 143 refers to the copy information 143a and determines an identifier of the copy source storage apparatus. The copy controller section 143 refers to the connection information 142a retained by the connection manager section 142, and determines whether or not the identifier of the copy source storage apparatus is set as the connection destination disk of a “busy” connection. The copy controller section 143 determines that the server accessing the copy source storage apparatus exists when the identifier of the copy source storage apparatus is identical to the identifier of the connection destination disk of an established connection (“busy” connection). When the server accessing the copy source storage apparatus exists, the process proceeds to an operation S17. When no server accessing the copy source storage apparatus exists, the process proceeds to an operation S14.

(Operation S14) When no server accessing the copy source storage apparatus exists, the copy controller section 143 starts data reading from the copy source storage apparatus. For example, the copy controller section 143 sets the address that has been set to “RAddr” to a read execution address “Read Addr”. The copy controller section 143 reads data that corresponds to the read execution address “Read Addr” from the copy source storage apparatus indicated in the copy information 143a. For example, the copy controller section 143 reads one block of the data. The process proceeds to an operation S15.

The data read process is performed based on control of the SAS controller section 141. For example, the copy controller section 143 outputs a data read command designating the identifier of the copy source storage apparatus and the read execution address “Read Addr” to the SAS controller section 141. The SAS controller section 141 reads data from the copy source storage apparatus according to the data read command, and passes the data to the copy controller section 143.

(Operation S15) The copy controller section 143 determines whether or not an OPEN event for the copy source storage apparatus is received. For example, the copy controller section 143 determines that the OPEN event for the copy source storage apparatus is received when certain information, which indicates an occurrence of the OPEN event from the server to the copy source storage apparatus, is set in the connection information 142a of the connection manager section 142. When the copy controller section 143 receives the OPEN event for the copy source storage apparatus, the process proceeds to an operation S16. When the copy controller section 143 receives no OPEN event for the copy source storage apparatus, the process proceeds to an operation S18.

(Operation S16) When the OPEN event for the copy source storage apparatus is received, the copy controller section 143 interrupts the data reading from the copy source storage apparatus. The copy controller section 143 sets the read start address “RAddr” to an address of next read data. The address of next read data may be, for example, an address obtained by adding an equivalent value of one block to the read execution address “Read Addr” that indicates the last read data.

(Operation S17) When the server accessing the copy source storage apparatus exists, the copy controller section 143 waits until a CLOSE event of the server that is accessing is detected. For example, the copy controller section 143 determines that the CLOSE event for the copy source storage apparatus is received when certain information, which indicates an occurrence of the CLOSE event sent from the server to the copy source storage apparatus, is set in the connection information 142a of the connection manager section 142. When the copy controller section 143 detects the CLOSE event of the server that is accessing, the process proceeds to the operation S13.

(Operation S18) When no OPEN event for the copy source storage apparatus is received, the copy controller section 143 determines whether or not reading of a specified number of blocks (Ablk) ends. The specified number of blocks (Ablk) may be the number of blocks that may be transferred in a single transfer process. The specified number of blocks (Ablk) may be, for example, set to a predetermined value in advance in the copy controller section 143. The specified number of blocks (Ablk) may be set to the number of blocks that is equal to or less than a storage capacity of the memory 144. When the copy controller section 143 finishes the reading of the specified number of blocks, the process proceeds to an operation S19. When the copy controller section 143 does not finish the reading of the specified number of blocks, the process proceeds to the operation S15.

(Operation S19) When the reading of the specified number of blocks of the data finishes, the copy controller section 143 stores the read data in the memory 144. The process proceeds to an operation S31 illustrated in FIG. 8.

(Operation S31) The copy controller section 143 determines whether or not a server accessing the copy destination storage apparatus exists. For example, the copy controller section 143 refers to the copy information 143a and identifies an identifier of the copy destination storage apparatus. The copy controller section 143 refers to the connection information 142a retained by the connection manager section 142, and determines whether or not the identifier of the copy destination storage apparatus is set as the connection destination disk of a “busy” connection. The copy controller section 143 determines that the server accessing the copy destination storage apparatus exists when the identifier of the copy destination storage apparatus is identical to the identifier of the connection destination disk of an established connection (“busy” connection). When the server accessing the copy destination storage apparatus exists, the process proceeds to an operation S35. When no server accessing the copy destination storage apparatus exists, the process proceeds to an operation S32.

(Operation S32) When no server accessing the copy destination storage apparatus exists, the copy controller section 143 starts data writing to the copy destination storage apparatus. For example, the copy controller section 143 may set the address that has been set to “WAddr” to a write execution address “Write Addr”. The write execution address “Write Addr” indicates the address of write target data in the copy source storage apparatus. For example, the write target may be data read from an area of the copy source storage apparatus, which corresponds to the write execution address “Write Addr”.

The copy controller section 143 reads data of the write execution address “Write Addr” stored in the memory 144, and writes the data in the copy destination storage apparatus indicated in the copy information 143a. For example, the copy controller section 143 writes one block of the data. The process proceeds to an operation S33.

(Operation S33) The copy controller section 143 determines whether or not an OPEN event for the copy destination storage apparatus is received. For example, the copy controller section 143 determines that the OPEN event for the copy destination storage apparatus is received when certain information, which indicates an occurrence of the OPEN event sent from the server to the copy destination storage apparatus, is set in the connection information 142a of the connection manager section 142. When the copy controller section 143 receives the OPEN event for the copy destination storage apparatus, the process proceeds to an operation S34. When the copy controller section 143 receives no OPEN event for the copy destination storage apparatus, the process proceeds to an operation S36.

(Operation S34) When the OPEN event for the copy destination storage apparatus is received, the copy controller section 143 interrupts the data writing to the copy destination storage apparatus. The copy controller section 143 sets the write start address “WAddr” to an address of next write data. The address of next write data may be, for example, an address obtained by adding the equivalent value of one block to the write execution address “Write Addr” that is the address of the last write data.

(Operation S35) When there is the server accessing the copy destination storage apparatus, the copy controller section 143 waits until a CLOSE event of the server that is accessing is detected. For example, the copy controller section 143 determines is detected that the CLOSE event for the copy destination storage apparatus when certain information, which indicates an occurrence of the CLOSE event sent from the server to the copy destination storage apparatus, is set in the connection information 142a of the connection manager section 142. When the copy controller section 143 detects the CLOSE event of the server that is accessing, the process proceeds to the operation S31.

(Operation S36) When no OPEN event for the copy destination storage apparatus is received, the copy controller section 143 determines whether or not the writing of the specified number of blocks (Ablk) ends. When the writing of the specified number of blocks ends, the process proceeds to an operation S37. When the writing of the specified number of blocks does not end, the process proceeds to the operation S33.

(Operation S37) The copy controller section 143 determines whether or not a transfer of the total number of blocks (#blk) finishes. When the transfer of the total number of blocks finishes, the copy control process ends. When there are blocks yet to be transferred, the process proceeds to the operation S13 illustrated in FIG. 7.

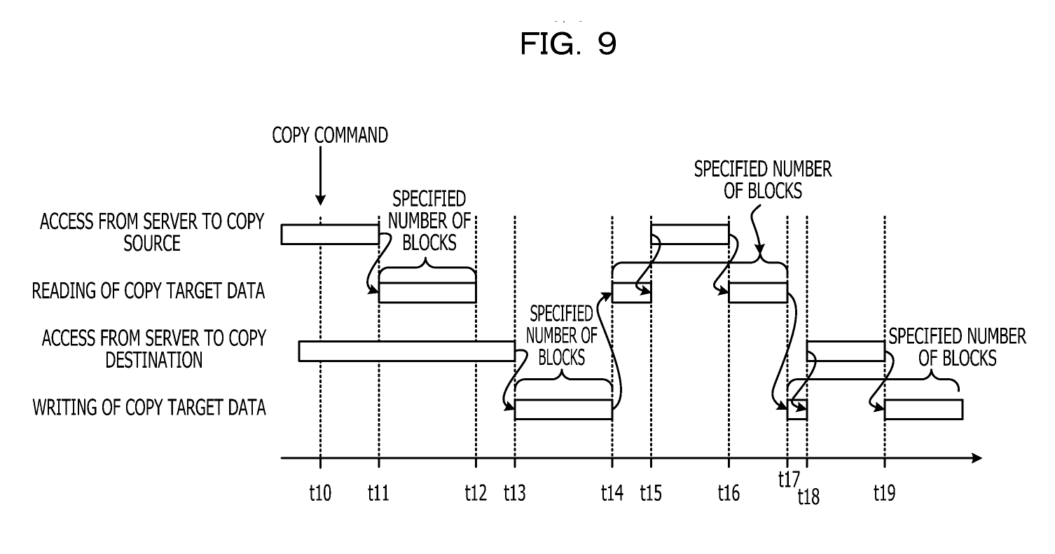

Data copying between storage apparatuses may be performed in periods when no access is being made to these storage apparatuses. FIG. 9 illustrates an exemplary copy control process. FIG. 9 illustrates execution time slots of an access process from a server to a copy source, a read process of copy target data, an access process from a server to a copy destination, and a write process of copy target data. For example, in FIG. 9, at time t10, a copy command is input to the switch 100.

At the time t10, an access may be being made to the copy source storage apparatus. Accordingly, no reading of the copy target data is performed until the access to the copy source storage apparatus ends.

At time t11, when the access from the server to the copy source storage apparatus ends, the copy target data is read from the copy source storage apparatus. The data thus read is stored in the memory 144 in the switch 100.

At time t12, the reading of the specified number of blocks of the copy target data finishes, and the data read process ends. At this time, an access is being made from the server to the copy destination storage apparatus. Accordingly, no writing of the copy target data is performed until the access to the copy destination storage apparatus ends.

At time t13, when the access from the server to the copy destination storage apparatus ends, the data stored in the memory 144 is written in the copy destination storage apparatus. At time t14, when the writing of the specified number of blocks of the data finishes, the data write process ends. At this time, no access is being made from the server to the copy source storage apparatus. Accordingly, the reading of the copy target data from the copy source storage apparatus starts.

At time t15, an access from the server to the copy source storage apparatus starts. At this time, the reading of the copy target data from the copy source storage apparatus is interrupted. At time t16, when the access from the server to the copy source storage apparatus ends, a remaining data of the specified number of blocks is read from the copy source storage apparatus.

At time t17, the reading of the specified number of blocks of the copy target data finishes, and the data read process ends. At this time, no access is being made from the server to the copy destination storage apparatus. Accordingly, the writing of the copy target data to the copy destination storage apparatus starts.

At time t18, an access from the server to the copy destination storage apparatus starts. At this time, the writing of the copy target data to the copy destination storage apparatus is interrupted. At time t19, when the access from the server to the copy destination storage apparatus ends, a remaining data of the specified number of blocks is written to the copy destination storage apparatus.

The data copying such as backups between the storage apparatuses, etc. may be performed without affecting accessibility to the storage apparatuses from the servers. For example, accesses from the servers to the storage apparatuses are being monitored, and no reading or writing of the copy target data is performed for the storage apparatus that is being accessed. Accordingly, occurrences of conflicts between the server's disk access and the copying operation may be reduced, and effects of the data copying between the storage apparatuses to the server operations may be reduced.

The data copying between the storage apparatuses are performed through the switch 100, and does not go through a small-bandwidth communication channel such as a LAN. Accordingly, occupying the LAN bandwidth by the data copying between the storage apparatuses may be reduced, and effects to other communications that go through the LAN may be reduced.

Wide-bandwidth transmission channels of SAS-2 are used to couple between the switch 100 and the storage apparatuses. The data copying is performed using the wide-bandwidth transmission channel. Thus, the copying may end within a short period of time.

Since the switch 100 controls the copying, the server may fail to include a function for the data copying between the storage apparatuses. Accordingly, when the data copying between the storage apparatuses are performed, server's loads may be reduced.

Since the copy control mechanism of the switch 100 is used, a manager server other than the servers 31-33 may be omitted. When a connection is established between the server and the storage apparatus, it is determined that the storage apparatus is being accessed, and the data copying is interrupted before the start of data writing or reading by the server from/to the storage apparatus. Accordingly, the access conflicts may be reduced, and a reduction of data accessibility from the servers may be alleviated.

Presence or absence of an access from the server to the storage apparatus is determined by detecting presence or absence of a connection established between the server and the storage apparatus. For example, the switch 100 may monitor transmissions of access requests for reading or writing, and acknowledgements in response to the access requests. A period from a transmission of the access request to a reception of the acknowledgement may be considered as a period when an access is being made.

The foregoing processing functions may be performed by a computer. There is provided a program that describes processes of functions included in the controller circuit 140 of the switch 100. The program is executed by a CPU provided in the switch 100. The program that describes the processes may be recorded in a computer-readable recording medium. The computer-readable recording medium includes a magnetic memory device, an optical disc, a magneto-optical recording medium, a semiconductor memory, or the like. The magnetic memory device includes a Hard Disk Drive (HDD), a Flexible Disk (FD), a magnetic tape, or the like. The optical disc includes a DVD, a DVD-RAM, a CD-ROM/RW, or the like. The magneto-optical recording medium includes a Magneto-Optical disk (MO). The recording medium that records the program does not include a transitory propagating signal itself.

In marketing of the program, for example, portable recording media such as DVDs, CD-ROMs, in which the program is recorded, are marketed. The program may be stored in a memory device of a server computer, and may be transferred to other computers from the server computer through a network.

A computer that executes the program stores, for example, the program recorded in the portable recording medium or transferred from the server computer in its own memory device. The computer reads the program from its own memory device, and performs the processes according to the program. The computer may directly read the program from the portable recording medium, and performs the processes according to the program. The computer may perform the processes according to the program every time it receives the program transferred from the server computer.

At least part of the functions included in the controller circuit 140 may be executed by an electronic circuit such as a Digital Signal Processor (DSP), an Application Specific Integrated Circuit (ASIC), a Programmable Logic Device (PLD), or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A relay apparatus comprising:
a relay section that relays a communication between an information processing apparatus and one of a first storage apparatus and a second storage apparatus;
a determination section that monitors the communication and to detect a first access to one of the first storage apparatus and the second storage apparatus from the information processing apparatus; and
a copy section that copies data from the first storage apparatus to the second storage apparatus while one of the first storage apparatus and the second storage apparatus is not accessed in response to a copy command of the data from the first storage apparatus to the second storage apparatus.

2. The relay apparatus according to claim 1,
wherein the copy section reads the data from the first storage apparatus during a period when the information processing apparatus do not access the first storage apparatus; and
the copy section writes the read data to the second storage apparatus during a period when the information processing apparatus do not access the second storage apparatus.

3. The relay apparatus according to claim 1,
wherein, when a second access from the information processing apparatus to the first storage apparatus is detected during a data read operation from the first storage apparatus, the copy section interrupts the data read operation from the first storage apparatus until the second access ends.

4. The relay apparatus according to claim 1,
wherein, when a third access from the information processing apparatus to the second storage apparatus is detected during a data write operation to the second storage apparatus, the copy section interrupts the data write operation to the second storage apparatus until the third access ends.

5. The relay apparatus according to claim 1,
wherein the copy section stores data read from the first storage apparatus in a memory section, and writes the data stored in the memory section to the second storage apparatus.

6. The relay apparatus according to claim 1,
wherein the determination section monitors a connection established between the information processing apparatus and one of the first storage apparatus and the second storage apparatus, and detects the first access during a period when the connection is established.

7. A data copy method comprising:
relaying a communication between an information processing apparatus and one of a first storage apparatus and a second storage apparatus;
monitoring the communication;
detecting an access from the information processing apparatus to one of the first storage apparatus and the second storage apparatus; and
copying data from the first storage apparatus to the second storage apparatus during a period when one of the first storage apparatus and the second storage apparatus is not accessed in response to a copy command of the data from the first storage apparatus to the second storage apparatus.

8. The data copy method according to claim 7, further comprising:
reading the data from the first storage apparatus during a period when the information processing apparatus does not access the first storage apparatus; and
writing the read data to the second storage apparatus during a period when the information processing apparatus does not access the second storage apparatus.

9. The data copy method according to claim 7, further comprising:
detecting a second access from the information processing apparatus to the first storage apparatus during a data read operation from the first storage apparatus; and
interrupting the data read operation from the first storage apparatus until the second access ends.

10. The data copy method according to claim 7, further comprising:
detecting a third access from the information processing apparatus to the second storage apparatus during a data write operation to the second storage apparatus; and
interrupting the data write operation to the second storage apparatus until the third access ends.

11. The data copy method according to claim 7, further comprising:
monitoring a connection established between the information processing apparatus and one of the first storage apparatus and the second storage apparatus; and
detecting the first access during a period when the connection is established.
